(19) United States
(12) Patent Application Publication
(10) Pub. No.: US 2025/0315835 A1
(43) Pub. Date: Oct. 9, 2025

(54) FRAUD ANALYSIS USING MACHINE LEARNING AND GENERATIVE ARTIFICIAL INTELLIGENCE

(71) Applicant: ACTIMIZE LTD, Ra'anana (IL)

(72) Inventors: Saberi CHATTOPADHYAY, San Jose, CA (US); Ralph LAO, San Jose, CA (US); Deborah LOPEZ, San Ramon, CA (US)

(21) Appl. No.: 18/630,468

(22) Filed: Apr. 9, 2024

(51) Int. Cl. G06Q 20/40

(52) U.S. Cl. CPC G06Q 20/4016

(57) ABSTRACT

A system is adapted to automatically identify patterns of potentially suspicious activity, and includes a processor configured to receive, with a user interface, a natural language user query regarding a potentially suspicious transaction, entity, or event. The processor converts the query to a structured query, and fetches relationship data related to the transaction, entity, or event from a relationship repository. For each relationship in the relationship data, the processor constructs a database query based on the structured query, retrieves a record from a query database, fetches customer data from a customer database, and aggregates all of this data into a preliminary prompt. With a prompt composer, the processor receives attributes from an attributes repository, and aggregates the attributes and the preliminary prompt to compose a response prompt. A large language model generates a natural language response related to the potentially suspicious transaction, entity, or event based on the response prompt.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to systems, devices, and methods for analyzing potentially suspicious transactions, risk factors, entities, or events. This fraud analysis system has particular but not exclusive utility for analysis of fraud and other financial crimes.

### BACKGROUND

Financial crime is now more sophisticated and faster with the pervasive adoption of instant payments and the commoditization of artificial intelligence (AI) technologies. The fight against financial crime may be coming to an inflection point where fraud and anti-money laundering (AML) analysts may be overwhelmed by the increase in true positive alerts, generating alert fatigue and exposing the organization to miss some instances of fraud, potentially leading to AML regulatory penalties.

Given the current number of experienced fraud analysts and the number of different solutions that they need to reference, operations may only be available on weekdays during regular business hours. It may currently be difficult for fraud analysts to expand their operations to 24×7×365 coverage, including weckends and holidays.

A sizable portion of fraud analysis is a manual process today, and depends heavily on the experience and expertise level of the analysts. With significant percentage of experienced Baby Boomer analysts currently retiring, this leaves a huge gap in knowledge and experience level for newcomers in the industry. This, in combination with the ongoing new fraud trends and sophisticated technology being easily available to the fraudsters, exposes financial institutions (FIs) to possible significant fraud loss, regulatory or legal fines, expensive lookbacks, reputational damage, and operational inefficiencies.

It is therefore to be appreciated that commonly used fraud analysis procedures and systems have numerous challenges, including a strong dependence on the time, attention, experience, and skill level of human analysts. Accordingly, a need exists for improved fraud analysis systems that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a fraud analysis system. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically identify patterns of potentially suspicious activity. The system includes a processor and a non-transitory computer readable medium operably coupled thereto. The non-transitory computer readable medium may include a plurality of instructions stored in association therewith that are accessible to, and executable by, the processor, to perform operations which may include, in real time or near-real time, receiving, with a user interface, a natural language user query regarding a potentially suspicious transaction, entity, or event. The instructions also include, with a data fetcher: converting the natural language user query to a structured query with a large language model and an instruction to the large language model; fetching relationship data related to the potentially suspicious transaction, entity, or event from a relationship repository; for each relationship in the relationship data: constructing a database query based on the structured query; retrieving, with the database query, a record from a query database. The instructions also include fetching customer data related to the potentially suspicious transaction, entity, or event from a customer database; and aggregating the retrieved record, the natural language query, and the customer data into a preliminary prompt. The instructions also include, with a prompt composer: receiving attributes related to the potentially suspicious transaction, entity, or event from an attributes repository; and aggregating the attributes and the preliminary prompt with the large language model to compose a response prompt. The instructions also include generating, with the large language model, a natural language response related to the potentially suspicious transaction, entity, or event based on the response prompt, and displaying the natural language response to the user with the user interface. Other embodiments of this aspect include corresponding computer systems, apparatus, and computer programs recorded on one or more computer storage devices, each configured to perform the actions of the methods.

Implementations may include one or more of the following features. In some embodiments, the relationship data may include both structured and unstructured data, where the structured and unstructured data may include at least one of customer data, account data, transaction data, both raw alert data and case data, and dispositioned alert and case data, risk factors, fraud match data, unusual behavior data, possible fraud pattern data, or link analysis data may include any of the above. In some embodiments, the customer data may include past behavior patterns or past confirmed fraud activities. In some embodiments, the attributes may include location data, account data, transaction data, reference data, or relationship data related to identifiers from the relationship repository. In some embodiments, the operations further may include, based on the attributes, automatically opening a case related to the potentially suspicious transaction, entity, or event. In some embodiments, the large language model is configured such that the natural language response may include a case narrative or case description for the potentially suspicious transaction, entity, or event. In some embodiments, the operations further may include, with training data, training the large language model. In some embodiments, the training data may include at least one of a database, a document, a web page, an internet site, alert data, case data, risk factors, or a plurality of confirmed fraud cases. In some embodiments, the operations further may include, with an attributes analyzer and a plurality of fraud cases, populating the attributes repository. In some embodiments, the operations further may include, with a relationship analyzer and a plurality of fraud cases, populating the relationship repository. Implementations of the described techniques may include hardware, a method or process, or computer software on a computer-accessible medium.

One general aspect includes a computer-implemented method. The computer-implemented method includes, with a processor and a non-transitory computer readable medium operably coupled thereto, in real time or near real time: receiving, with a user interface, a natural language user query regarding a potentially suspicious transaction, entity, or event. The method also includes, with a data fetcher: converting the natural language user query to a structured query with a large language model and an instruction to the large language model; fetching relationship data related to the potentially suspicious transaction, entity, or event from a relationship repository; for each relationship in the relationship data: constructing a database query based on the structured query; retrieving, with the database query, a record from a query database. The method also includes fetching customer data related to the potentially suspicious transaction, entity, or event from a customer database; and aggregating the retrieved record, the natural language query, and the customer data into a preliminary prompt. The method also includes, with a prompt composer: receiving attributes related to the potentially suspicious transaction, entity, or event from an attributes repository; and aggregating the attributes and the preliminary prompt with the large language model to compose a response prompt. The method also includes generating, with the large language model, a natural language response related to the potentially suspicious transaction, entity, or event based on the response prompt. The method also includes displaying the natural language response to the user with the user interface. Other embodiments of this aspect include corresponding computer systems, apparatus, and computer programs recorded on one or more computer storage devices, each configured to perform the actions of the methods.

Implementations may include one or more of the following features. In some embodiments, the relationship data may include additional potentially suspicious transaction, entity, or events similar to the potentially suspicious transaction, entity, or event. In some embodiments, the customer data may include past behavior patterns or past confirmed fraud activities. In some embodiments, the attributes may include location data, account data, transaction data, or reference data. In some embodiments, the operations further may include, based on the attributes, automatically opening a case for the potentially suspicious transaction, entity, or event. In some embodiments, the large language model is configured such that the natural language response may include a case narrative or case description for the potentially suspicious transaction, entity, or event. In some embodiments, the computer-implemented method may include, with training data, training the large language model. In some embodiments, the training data may include at least one of a database, a document, a web page, an internet site, or a plurality of fraud cases. In some embodiments, the computer-implemented method may include, with an attributes analyzer and a plurality of fraud cases, populating the attributes repository. In some embodiments, the computer-implemented method may include, with a relationship analyzer and a plurality of fraud cases, populating the relationship repository. Implementations of the described techniques may include hardware, a method or process, or computer software on a computer-accessible medium.

The fraud analysis system disclosed herein has particular, but not exclusive, utility for analysis of fraud and other financial crimes.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the fraud analysis system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation of a fraud analysis process, in accordance with at least one embodiment of the present disclosure.

FIG. 2 is a schematic, diagrammatic representation, in flow diagram form, of an example fraud management method, in accordance with at least one embodiment of the present disclosure.

FIG. 3 is a schematic, diagrammatic representation, in block diagram form, of an example fraud analysis system, in accordance with at least one embodiment of the present disclosure.

FIG. 4 is a schematic, diagrammatic representation, in block diagram form, of an example fraud analysis system, in accordance with at least one embodiment of the present disclosure.

FIG. 5 is a schematic, diagrammatic representation, in block diagram form, of an example fraud analysis system, in accordance with at least one embodiment of the present disclosure.

FIG. 6 is a schematic, diagrammatic representation, in block diagram form, of an example fraud analysis system, in accordance with at least one embodiment of the present disclosure.

FIG. 7 is a schematic, diagrammatic representation, in hybrid block diagram/flow diagram form, of an example data fetcher, in accordance with at least one embodiment of the present disclosure.

FIG. 8 is a schematic, diagrammatic representation, in hybrid block diagram/flow diagram form, of an example prompt composer, in accordance with at least one embodiment of the present disclosure.

FIG. 9 is a schematic, diagrammatic representation, in hybrid block diagram/flow diagram form, of an example fraud analysis system, in accordance with at least one embodiment of the present disclosure.

FIG. 10 is a schematic, diagrammatic representation, in hybrid block diagram/flow diagram form, of an example fraud analysis system, in accordance with at least one embodiment of the present disclosure.

FIG. 11 is a schematic, diagrammatic representation, in flow diagram form, of an example fraud analysis method, in accordance with at least one embodiment of the present disclosure.

FIG. 12 is a schematic, diagrammatic representation, in block diagram form, of an example fraud analysis system, in accordance with at least one embodiment of the present disclosure.

FIG. 13 is a screen display showing a graphical representation of an alerted transaction, in accordance with at least one embodiment of the present disclosure.

FIG. 14 is a screen display showing link analysis generation, in accordance with at least one embodiment of the present disclosure.

FIG. 15 is a screen display showing link analysis generation, in accordance with at least one embodiment of the present disclosure.

FIG. 16 is a screen display showing a fraud analysis process in a fraud analysis host application, in accordance with at least one embodiment of the present disclosure.

FIG. 17 is a screen display showing a fraud analysis process in a fraud analysis host application, in accordance with at least one embodiment of the present disclosure.

FIG. 18 is a screen display showing a fraud analysis process in a fraud analysis host application, in accordance with at least one embodiment of the present disclosure.

FIG. 19 is a screen display showing a fraud analysis process in a fraud analysis host application, in accordance with at least one embodiment of the present disclosure.

FIG. 20 is a schematic, diagrammatic representation, in flow diagram form, of an example integration method, by which the fraud analysis system can be customized and integrated into a host application, in accordance with at least one embodiment of the present disclosure.

FIG. 21 is a schematic diagram of a processor circuit, in accordance with at least one embodiment of the present disclosure.

### DETAILED DESCRIPTION

In accordance with at least one embodiment of the present disclosure, a fraud analysis system is provided which offers ways to boost efficiency of the fraud analysis process by automating approximately 70%-80% of the process, including but not limited to fraud detection, possible fraud identification, fraud monitoring, narrative documentation, and preferably combinations of the foregoing. Thus, the fraud analysis system of the present disclosure can fight financial crime on a continuous (e.g., 24×7×365) basis, and can screen, monitor, and intervene in real-time. This can in turn free up approximately 70%-80% of the time currently spent by human fraud analysis, by streamlining the fraud review process, thus enabling the analysts to focus on higher-value portions of the fraud analysis process. The system can also reduce costs on fraud alert-to-case-to-intervention workflow, reduce alert triage time, and reduce or prevent alert fatigue.

The combination of four distinct segments of fraud analysis-fraud detection, possible fraud identification, fraud monitoring, and narrative documentation-can cover approximately 70%-80% of the labor efforts currently spent by human analysts. The present disclosure accomplishes this through a multi-step process.

First—Automate the creation of new fraud cases based on a combination of high risk and/or unusual risk factors, and activities within a finite history of the potentially suspicious transaction's account and/or party.

Second—Automate the process of link analysis across multiple channels (e.g., cross-channel analysis), including but not limited to wire, automated clearinghouse receiving depository financial institution (ACH RDFI), automated clearinghouse originating depository financial institution (ACH ODFI), checking, online banking, transaction monitoring, AML, etc. that will process through the available data (e.g., using data mining techniques) within a finite history or timeline. This can occur across multiple data types, including but not limited to customer data, transaction data, account data, reference data, etc. This can also occur across multiple lists or sources, such as watchlists, Office of Foreign Assets Control (OFAC) lists, sanctions lists, 314a lists, internal deny lists, whitelists, etc. The population of lists or sources may expand over time.

Third—Auto-identify possibility of fraud pattern. Learning from the existing data and processed information on confirmed fraud cases, the system uses a combination of risk models and GenAI to auto-identify possible fraud patterns, including but not limited to a mule pattern, account take over (ATO), scams, brute force attack (BFA), Internet-online fraud, compromised credentials, phishing, smishing, romance scams, sweepstakes/lottery scams, social engineering, etc.

Fourth—Auto-draft a case narrative using a custom natural-language GenAI purpose-built for fraud analysis based on all of the above, plus customer data, account data, transaction data, behavioral data, etc. This will also include link analysis results in the case narrative.

The combination of all four of these segments of fraud analysis, (e.g., fraud detection, fraud identification, fraud monitoring, and narrative documentation), will typically result in a savings of approximately 70%-80% of the labor currently spent on fraud analysis, thus making it easier for FIs and service providers to expand fraud detection services beyond weekday business hours and to make such services more efficient. With these features, the fraud analysis system can assist in better managing high volumes of alerts, and narrow in on known fraud patterns, such as mule accounts, by streamlining the monitoring process. Analysts will thus be able to spend more quality time on those alerts that require more attention and more due diligence time. The system can also address the problem of the experience and expertise gap arising primarily because of experienced analysts retiring. This automation will provide the opportunity to better align processes and the ability to manage overall volumes efficiently. In addition, the fraud management system will address the fundamental problem of both batch and real-time fraud detection in the face of ongoing new fraud trends and sophisticated technology being used by fraudsters. This can protect FIs from possible fraud loss, regulatory or legal fines, expensive lookbacks, reputational damage, and operational inefficiencies. This will also address the problem of experience and expertise gap arising primarily because of experienced analysts retiring. This automation will provide the opportunity to better align processes and the ability to manage overall volumes efficiently.

Leveraging GenAI for high-accuracy batch and real-time alerts, the fraud analysts can manage repetitive alerts patterns, consolidate this information and trigger automatic case generation with the right narrative, and actionable evidence for intervention while recommending investigation paths for complex cases. Its fine-tuned, custom GenAI Large Language Models (LLMs) will enable natural language search and case narration, embeddable within existing software tools.

If the input is from a chat from a fraud analyst using the fraud GenAI assistant of the present disclosure's fraud management system, the system can use the LLM to interpret the user's natural language inputs and parse them to application program interface (API) compatible chunks to process. The system can get data from product databases (and/or vector embedded databases if needed) and feed the data to the LLM to produce output exclusively for the product information provided. The LLM may be tailored to process natural language input and produce natural language responses. The LLM may predict what is most likely the next word given based on the most recent chat action. Because of its nature, the LLM can hallucinate and come up with something that doesn't necessarily exist. One way to mitigate hallucination is to provide the LLM with the exact information and ask it to respond based on exclusively on the input provided-a discipline known as prompt engineering.

In a prompt engineering example, a natural language input such as “perform link analysis” may be converted into a detailed LLM prompt such as:
f″Describe in any relationship you can find in this transaction to others, show both in terms of relationship in bullet points and an English paragraph to summarize. Account:
{account] \nTransaction:
{transaction} \nReference:
{reference} \nAccount:
{relationship} \nFraud Type:
{fraud_type} \n″
Where
Account=“account xyz was opened in May 2019 at New York, NY, USA. Birthday Dec. 31, 1978. Race: White. Current Balance is $3,234,230. Monthly balance for 2023 is $3,432,309.”
Transaction=“Time: July 17, 5: 21 PM PST; Wire Activity; Recipient: John Lynch; Amount: $500,000, Routing Number: 23493249; Account Number: 23432232, Country: Nigeria” Reference=“PFAC: Nigeria”
Relationship=“John Lynch Transferred $500,000 to another account, RTX, at July 18, 7:12 AM PST. The RTX has received over $3,000,000 in the last 3 days.
Fraud Pattern=“Fraud Pattern: 1. Mule, 2. Money Laundering.”
Output=“—The account was opened in May 2019 in New York, NY, however the birthday is listed as Dec. 31, 1978 and the race is listed as white.
   The current balance is $3,234,230 and the monthly balance for 2023 is $3,432,309.
   On July 17, 5:21 PM PST, John Lynch transferred $500,000 to another account, RTX, with a routing number of 23493249, an account number of 23432232, and in the country of Nigeria.
   The RTX has received over $3,000,000 in the last 3 days.”

In another example, a natural language prompt such as “Generate case” may be converted into an LLM prompt such as:
f″Describe in detail why this transaction is suspicious with Attribute: {attribute} \n
Risk Factor {risk_factor} \n
History: {history} \n
Account: {account} \n
Case Rules: {case_rules} \n″
Where:
Attribute=“location: Paris, France; Time: 3:01 PM Paris time; Wire Activity: Recipient: John Doe; Routing Number 23493249; Account Number: 23432232”
Risk Factor=“new location, new recipient, unusual amount:
History=“this account has a fraudulent transaction in May 2022 where $20,400 was stolen via a wire transfer due to compromised login credential”
Account=“account 2342433 was opened in March 2018 at Chicago, IL, USA. Current Balance is $234,230. Monthly Balance for 2023 is 432,309.”
Fraud Pattern=“Fraud Pattern: 1. New location, 2. New recipient”
Output=“This transaction is considered suspicious because:
1. This is a new location for this account—Paris, France
2. This is a new recipient for this account—John Doe
3. The amount being transferred—$20,400—is outside of the usual range for this account
History:
1. This account has a fraudulent transaction in May 2022 where $20,400 was stolen via a wire transfer due to compromised login credentials.
2. This account was opened in March 2018 in Chicago, IL, USA.
3. The current balance for this account is $234,230.
4. The monthly balance for this account in 2023 was 432,309.”

For alerts with highest risk priority, the present system will auto create cases and will auto-draft case narratives. It will also include links to similar cases. This will help analysts with operational efficiency gains.

Based on the question asked by the analyst, the fraud GenAI assistant will offer some possible recommendations and/or suggestions to the analyst as one or more action items of what the analyst could elect to do next. Data for this include user behavior metadata (e.g., visited pages, workflows, type of alerts, type of channels, case notes, working hours, workloads, velocity, executed suggestion items, prompts to assistant, UI feature usage and user preferences.) When a suggestion is taken/executed/applied by user, the feedback rating of the suggestion moves higher. This can be used to track how well the suggestion system is working.

It can answer questions like:
how many unique users have used the system.
what's the daily usage of the system.
what are the top 10 favorites/hottest suggestion items.
what's the most used suggestion item among <User Role>

It can also be used to funnel further for collaborative filtering.

In an example, the fraud management system/GenAI assistant uses a private LLM model instead of public LLM models, because the Financial Crimes domain includes a variety of sensitive information. A private LLM model allows the system to maintain full security on data, ensuring that no third party will have the data. There may also be no processing fees for an entity that owns both the private LLM and the hardware on which it executes. This may also provide more flexibility on what LLM to use.

Following are example data models returned by the LLM depending on the type of user query.

### Generic Example

User: How to open a case?

```
LLM:
{
  “type”: [“generic”],
  “query”: “How to open a case?”
}
```

### List Example

User: Show me all red wire alerts having risk factor MuleRisk

LLM:

```
{
  “type”: [“list”],
  “answer”: “All red wire alerts having risk factor MuleRisk are shown
in the Alerts screen”,
  “subject”: “alert”,
  “criteria”: {
  “conditions”: [
  {
    “key”: “risk_factor”,
    “mode”: “IS”,
    “value”: “MuleRisk”
  },
  {
    “key”: “channel”,
    “mode”: “IS”,
    “value”: “Wire”
  }
  ]
},
“limit”: 10,
}
```

### Count Example

User: How many check cases were opened in Q1 2023

LLM:

```
{
  “type”: [“count”],
  “answer”: “There were total {count} cases opened in Q1 2023”,
  “subject”: “case”,
  “criteria”:
  {
    “op”: “AND”,
    “conditions”: [
      {
        “key”: “created_date”,
        “mode”: “BETWEEN”,
        “value”: [“01/01/2023”, “31/03/2023”]
      },
      {
        “key”: “channel”,
        “mode”: “IS”,
        “value”: “Check”
      }
    ]
  }
}
```

### Action Example

User: Save last performed search as a favorite search with name “favorite1”

LLM:

```
{
  “type”: [“action”],
  “answer”: “Your last search was saved as a favorite with name favorite1. You can
perform this search whenever you want by specifying the name”,
  “action”: “save_favorite”,
  “favorite_name”: “favorite1”,
  “favorite_data”: “Show me all red wire alerts having risk factor MuleRisk”
}
```

Example source code for constructing and sending a prompt to the LLM includes:

```
def query_openai(query, prompts, max_tokens=150):
  openai.api_type = “azure”
  openai.api_key = config.openai_api_key
  openai.api_base = config.openai_api_base
  openai.api_version = config.openai_api_version
  messages = prompts + [{‘role’: ‘user’, ‘content’: query } ]
  try:
    # single_source, sources = get_context_sources(messages)
    response = openai.ChatCompletion.create(
    model=config.chatgpt_model,
    # model=“gpt-3.5-turbo”,
    deployment_id=config.openai_deployment_id,
    temperature=0,
    # max_tokens=150,
    messages=base_messages + messages)
  messages.append(response.choices[0].message)
  print(response)
  try:
    value = response.choices[0].message.content
    if re.search(r′,\n\s+}$′,value):
      value = re.sub(r′,\n\s+}$′, ‘}’, value)
    content = json.loads(value[value.index(‘{’):])
    # let LLM takes the lead
    message = content.get(‘response’)
    # sources = sources if single_source else f‘({ sources}) a’
    sql = content.get(‘sql’,″) #.replace(‘data_table’, sources)
    sql = sql.replace(‘‘‘inbound’’’, ‘‘‘Inbound’’’).replace(‘‘‘outbound’’’,
  ‘‘‘Outbound’’’).replace(‘‘‘international’’’, ‘‘‘International’’’).replace(‘‘‘demostic’’’,
  ‘‘‘Demostic’’’)
    sources = get_context_sources(messages, sql)
    if ‘{latest_date}’ in sql or ‘{latest_date}’ in message or ‘between { start_date }
  and {end_date}’ in sql:
      latest_alert_date = get_latest_date(sources)
      # latest_alert_date =_ query(f‘select date(created_date) as date from
    {sources} order by created_date desc limit 1’)[0][‘date’]
      # latest_alert_date = f‘‘‘{latest_alert_date}’’’
      message = message.replace(‘{latest_date}’,latest_alert_date)
    if ‘{ count}’ in message:
      count = get_count_of_latest_date(sources, latest_alert_date)
      # count =_ query(f‘select count(*) as count from { sources} where
    date(created_date) = {latest_alert_date }’)[0][‘count’]
      message = message.replace(‘{count}’, count)
    sql = sql.replace(‘{latest_date}’, latest_alert_date)
    sql = sql.replace(‘between { start_date} and {end_date}’,
    f‘={latest_alert_date}’)
    if ‘{count}’ in message:
      if ‘count(*)’ not in sql:
        count = get_count(sources, sql)
      else:
        result = _ query(sql)[0]
        count = str(result[next(iter(result))])
      message = message.format(count=count)
  if ‘{’ in sql:
    print(‘unknown scenario from LLM, trying to solve it’, sql)
    sql = sql.replace(‘{start_date}’, ‘‘‘2000-01-01’’’).replace(‘{end_date}’,
  ‘‘‘NOW( )’’’)
    sql = re.sub(‘\{ *\}’,‘’, sql)
except Exception as ex:
    print(‘extracting content failed ... ’)
    traceback.print_exception(type(ex), ex, ex .__traceback__)
    content = { }
    sql = ‘’
    message = ‘’ or response.choices[0].message.content
return {
  ‘prompts’: messages,
  ‘message’: response.choices[0].message,
  ‘recommendations’:content.get(‘recommendations’, [ ]),
  ‘answer’: message,
  ‘sql’: base64.b64encode(sql.encode( )).decode( ) if sql else ‘’
}
except Exception as e:
  traceback.print_exception(type(ex), ex, ex .__traceback__)
  return { ‘prompts’: messages, ‘error’: str(e)}
```

The present disclosure aids substantially in fraud analysis, by improving the speed and throughput of individual analysts, by automating fraud analysis processes traditionally requiring human cognition, rendering them instead as vector operations in a multidimensional space via machine learning and large language models. Implemented on a processor in communication with one or more databases, the fraud analysis system disclosed herein provides practical automation of previously un-automatable fraud analysis processes or processes that were impractical or infeasible to automate. This improved fraud analysis process transforms suspicious activity alerts into automated cases with formatted case narratives, without the normally routine need for a human to expend minutes or hours of labor assembling all of the relevant data. This unconventional approach represents an improvement in the technology of large language models, and improves the functioning of the fraud analysis computer, by reducing the amount of time, memory, and user input required to achieve a given level of analysis and reporting for potentially suspicious transactions, entities, or events. It also improves the functioning of the large language model, by tailoring it to fraud analysis applications.

The fraud analysis system may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the fraud analysis system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the fraud analysis system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

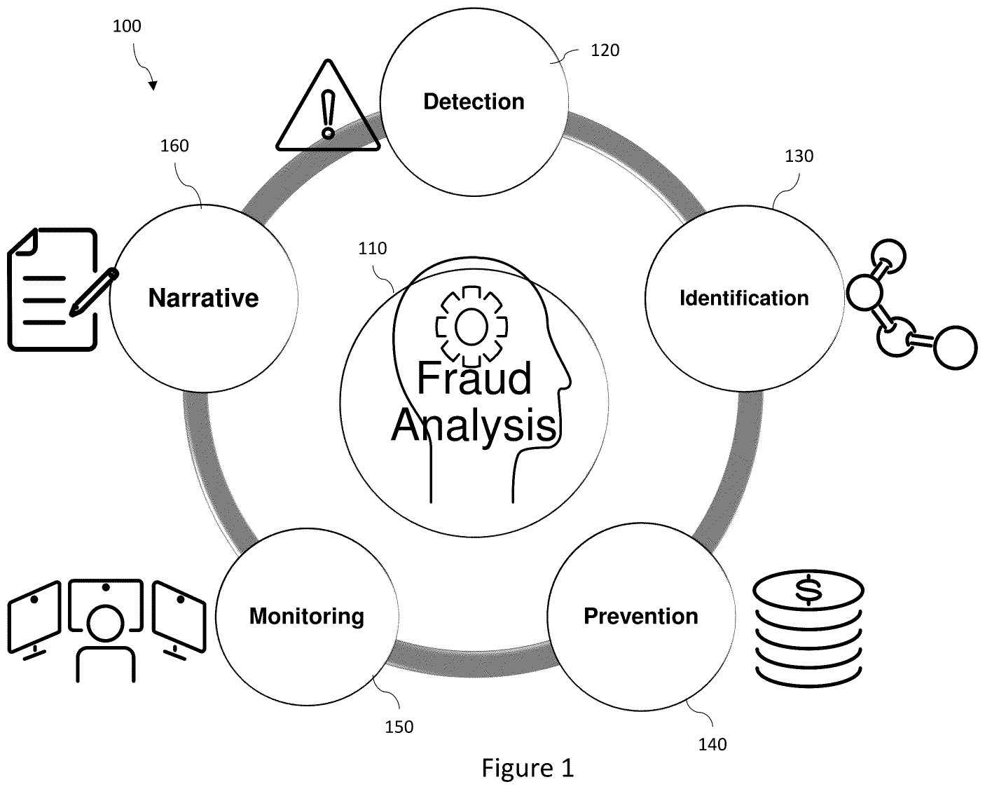

FIG. 1 is a schematic, diagrammatic representation of a fraud analysis process 100, in accordance with at least one embodiment of the present disclosure. The fraud analysis process 100 includes fraud analysis 110, whose components include detection 120, identification 130, prevention 140, monitoring 150, and narrative reporting 160. The fraud analysis system of the present disclosure can automate numerous aspects of these analysis steps. For example, automatic case creation can be triggered by high risk and/or unusual risk factors, activities, and other critical items that analysts should evaluate. Automatic link analysis can occur across multiple channels, can match against known fraud patterns, can incorporate customer, account, transaction, reference, and behavioral data, as well as lists including watchlists, OFAC lists, etc. Automatic identification of fraud patterns can involve training machine learning (ML) models and/or LLMs on existing data, processed data, confirmed fraud cases, high risk and unusual risk factors, client activities, and combinations of the foregoing categories. Automatic drafting of case narratives can involve natural language LLMs purpose-built for fraud, using customer, account, transaction, reference, and behavioral data, as well as link analysis and direct links to similar cases.

Before continuing, it should be noted that the examples described above are provided for purposes of illustration, and are not intended to be limiting. Other devices and/or device configurations may be utilized to carry out the operations described herein.

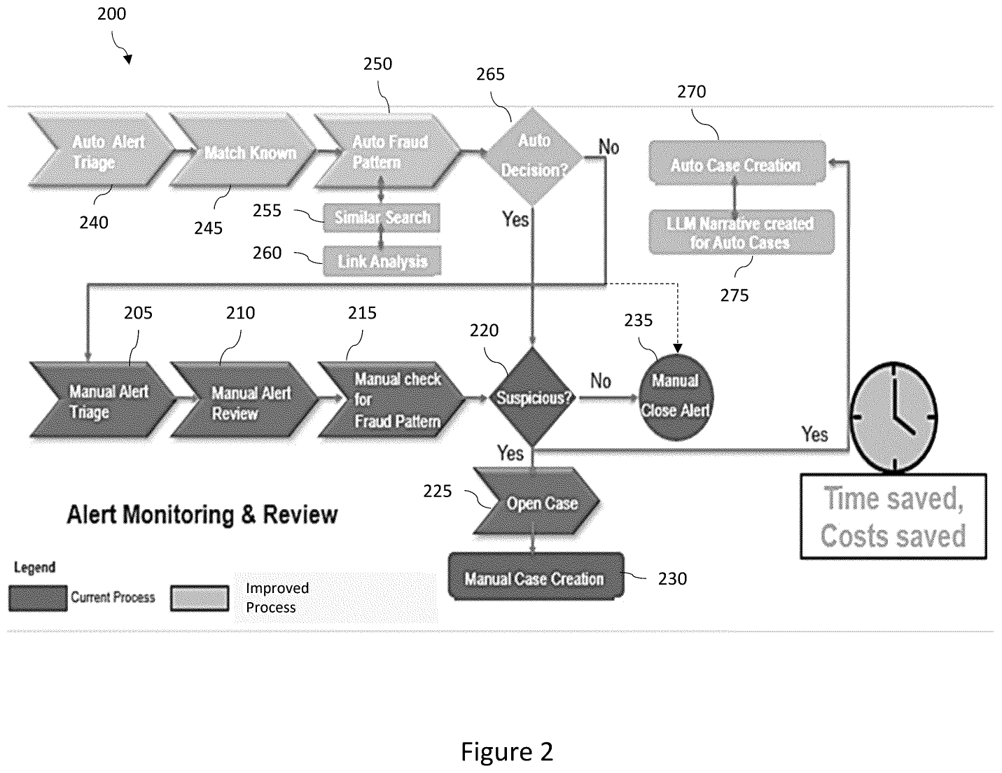

FIG. 2 is a schematic, diagrammatic representation, in flow diagram form, of an example fraud management method 200, in accordance with at least one embodiment of the present disclosure. It is understood that the steps of method 200 may be performed in a different order than shown in FIG. 2, additional steps can be provided before, during, and after the steps, and/or some of the steps described can be replaced or eliminated in other embodiments. One or more of steps of the method 200 can be carried by one or more devices and/or systems described herein, such as components of the system 300, system 400, system 500, system 600, system 900, system 1000, system 1200, and/or processor circuit 2150.

Steps 205-230 can occur in the present process, without the fraud analysis system of the present disclosure.

In step 205, the method 200 includes performing manual alert triage. This involves deciding, based on human judgment, which alerts are likely false positives or otherwise insignificant, and which are true, significant positives that merit further investigation. Execution then proceeds to step 210.

In step 210, the method 200 includes manually reviewing the alert on a given transaction. Execution then proceeds to step 215.

In step 215, the method 200 includes manually checking for a fraud pattern in the transaction and its associated account, customer, behavior, and relationship data. The relationship data may for example include both structured and unstructured data, including customer data, account data, transaction data, alert data, case data, fraud match data, unusual behavior data, possible fraud pattern data, or link analysis data including any of the above. Execution then proceeds to step 220.

In step 220, the method 200 includes manually determining, based on the fraud pattern or lack thereof, whether the transaction is genuinely suspicious. If yes, execution then proceeds to step 225. If no, execution proceeds to step 235.

In step 225, the method 200 includes opening a case file for the potentially suspicious transaction, entity, or event. Execution then proceeds to step 230.

In step 230, the method 200 includes manually populating the case file with data and narrative interpretations related to the potentially suspicious transaction, entity, or event. The method 200 is now complete.

In step 235, the method 200 includes manually closing the alert, because the transaction has been determined to be non-suspicious. The method 200 is now complete.

It is noted with particular emphasis that steps 205-235 can be expensive, time-consuming, error-prone, and highly dependent on the knowledge, expertise, and attention level of a human fraud analyst. Conversely, steps 240-275 occur in a novel process involving the fraud analysis system of the present disclosure, and occur in real time or near-real time in a repeatable, automated process that does not rely on human labor or expertise.

In step 240, the method 200 includes automatically triaging the alert using a ML model trained on real fraudulent and non-fraudulent transactions. Execution then proceeds to step 245.

In step 245, the method 200 includes automatically matching the alerted transaction against known fraudulent transactions. Execution then proceeds to step 250.

In step 250, the method 200 includes automatically detecting a fraud pattern, if any is present. This may involve subroutine calls to steps 255 and 260. Execution then proceeds to step 265.

In step 255, the method 200 includes performing a search for similar alerts to support the detection of a fraud pattern. Execution then returns to step 250.

In step 260, the method 200 includes performing a link analysis on the alert to see if it is directly associated with other alerts or known fraud, to support the detection of a fraud pattern. Execution then returns to step 250.

In step 265, the method 200 includes automatically determining whether a fraud pattern exists in the alerted transaction. If yes, execution then proceeds to step 220. If no, execution can then proceed to step 205 or step 235, depending on the implementation.

In some implementations, a “yes” result in step 220 transfers execution to step 270 rather than step 225.

In step 270, the method 200 includes automatically creating a case file for the potentially suspicious transaction, entity, or event. Execution then proceeds to step 275.

In step 275, the method 200 includes using an LLM to automatically create a case narrative for the automatically created case of step 270. The method 200 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information not otherwise available to the user.

The logic of flow diagrams may be shown as sequential. However, similar logic could be parallel, massively parallel, object oriented, real-time, event-driven, cellular automaton, batch mode, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, the decision as to whether a transaction is suspicious may occur within a span of less than one second, to avoid an impression of lag. Similarly, automatically creating and populating the case file may occur within a span of one second to avoid an impression of lag. These speeds, unachievable by a human analyst, may also be associated with greater accuracy and repeatability. The inputs and outputs of certain aspects of the method 200 may resemble those of mental processes, but are achieved by different means that cannot practically be performed in the mind, particularly in real time or near-real time.

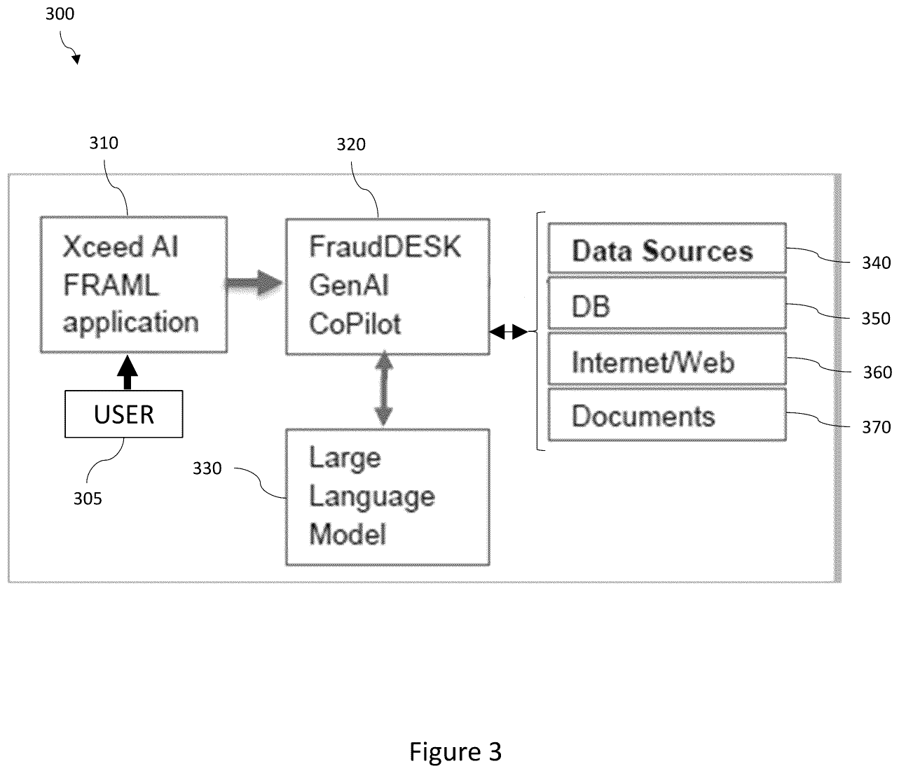

FIG. 3 is a schematic, diagrammatic representation, in block diagram form, of an example fraud analysis system 300, in accordance with at least one embodiment of the present disclosure. Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information not otherwise available to the user. Block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

The fraud analysis system 300 includes a host application 310, which may for example be a fraud analysis application, such as the FRaud detection and Anti-Money-Laundering (FRAML) application from Nice, LTD., or a component thereof. The fraud analysis system 300 also includes a generative AI (GenAI) assistant module or copilot module 320, which serves as an interface between the user 305, the host application 310, and a large language model (LLM) 330. The GenAI assistant 320 draws information from data sources 340, including but not limited to databases 350, Internet and web pages 360, and documents 370.

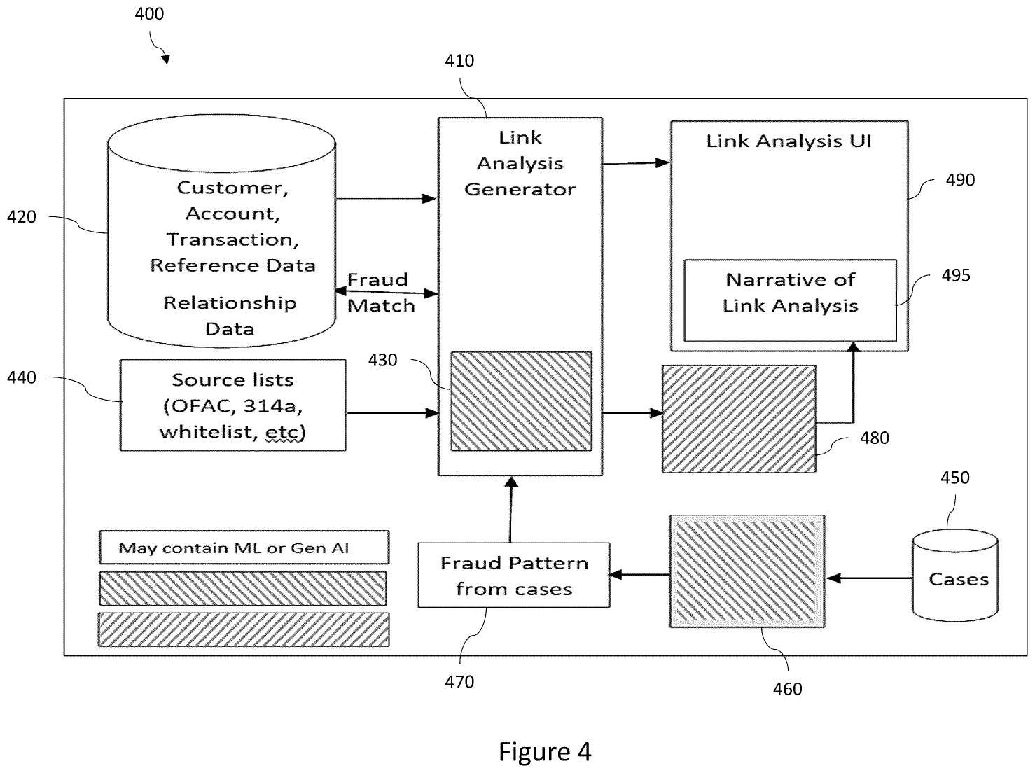

FIG. 4 is a schematic, diagrammatic representation, in block diagram form, of an example fraud analysis system 400, in accordance with at least one embodiment of the present disclosure. The fraud analysis system 400 includes a link analysis generator 410 that draws information from one or more databases 420 (which may include but is not limited to customer data, account data, transaction data, reference data, and relationship data). The link analysis generator 410 includes a fraud pattern identifier 430, which draws information from source lists 440 (which may include, but are not limited to OFAC lists, 314a lists, whitelists, and otherwise). The link analysis generator 410 provides outputs to the link analysis user interface 490, which may include a narrative 495 of the link analysis generated by a fraud narrative generator 480, which generates the narrative 495 based on fraud patterns identified by the fraud pattern identifier 430. The fraud pattern identifier 430 uses fraud patterns 470 that are extracted from a case database 450 by a fraud pattern generator 460.

Depending on the implementation, the link analysis generator 410 may contain or access a machine learning or GenAI component, the fraud narrative generator 480 may contain or access an LLM component, and the fraud pattern identifier 430 and fraud pattern generator 460 may contain or access a GenAI component.

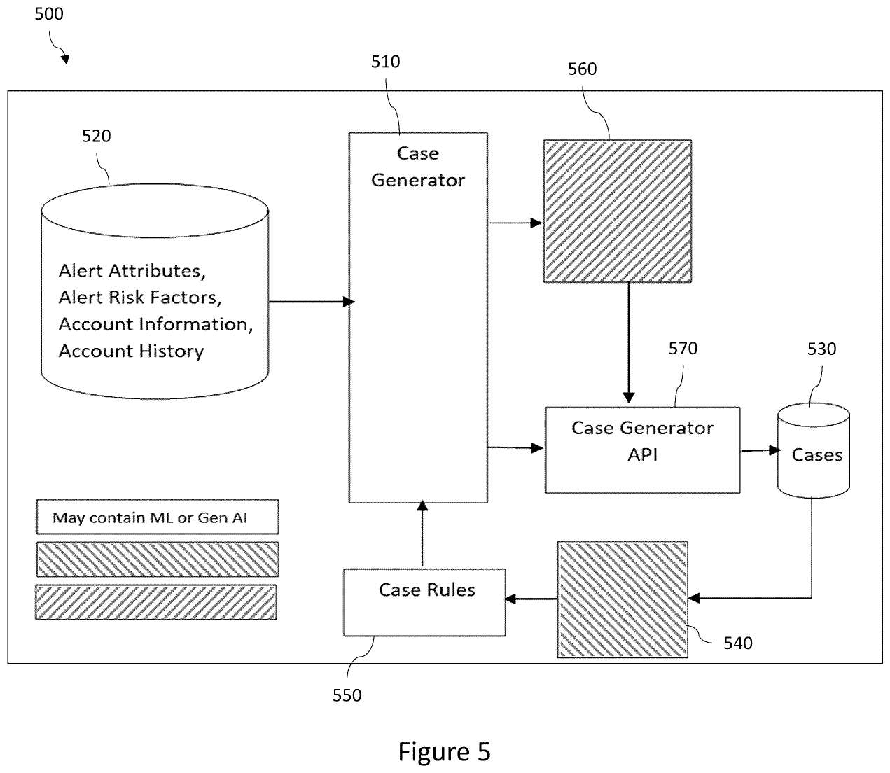

FIG. 5 is a schematic, diagrammatic representation, in block diagram form, of an example fraud analysis system 500, in accordance with at least one embodiment of the present disclosure. The fraud analysis system 500 includes a case generator 510 that draws information from one or more databases 520 (e.g., possibly including but not limited to alert attributes, alert risk factors, account information, and account history data). The case generator 510 sends case data to a case description generator 560, which generates a narrative description of the case. The case generator 510 and case description generator 560 may each send data to a case generator API, which stores the case in a cases database 530, which may include a case type identifier 540 and case rules 550, or information usable to derive the case type identifier 540 and case rules 550.

Depending on the implementation, the case generator 510 may include or access an ML or GenAI component, the case type identifier 540 may include or access a GenAI component, and the case description generator 560 may include or access an LLM component.

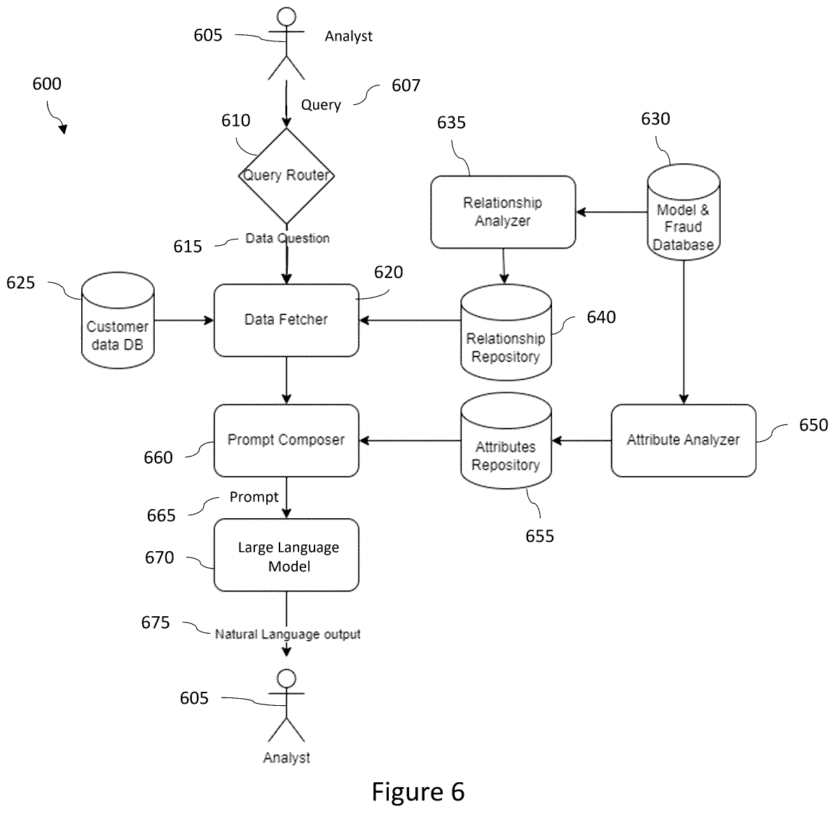

FIG. 6 is a schematic, diagrammatic representation, in block diagram form, of an example fraud analysis system 600, in accordance with at least one embodiment of the present disclosure. The fraud analysis system 600 includes a query router 610 that receives a natural language query 607 from a human analyst 605. The query router 610 converts the query 607 to a data question 615, which is received by a data fetcher 620. The data fetcher 620 receives data from a customer data database 625 and a relationship repository 640, which is populated by a relationship analyzer 635 receiving data from a model and fraud database 630. Customer data may for example include past behavior patterns and/or past confirmed fraud activities. The data fetcher 620 passes the fetched data to a prompt composer 660, which also receives data from an attributes repository 655 populated by an attributes analyzer 650 reading the model and fraud database 630. Attributes may for example include location data, account data, transaction data, reference data, or relationship data related to identifiers from the relationship repository.

The prompt composer 660 converts the attributes, the fetched data, the data question 615, and the query 607 into a prompt 665, which is passed to the LLM 670. The LLM 670 produces a natural language output (e.g., an informative response to the query 607), which is then displayed to the analyst 605.

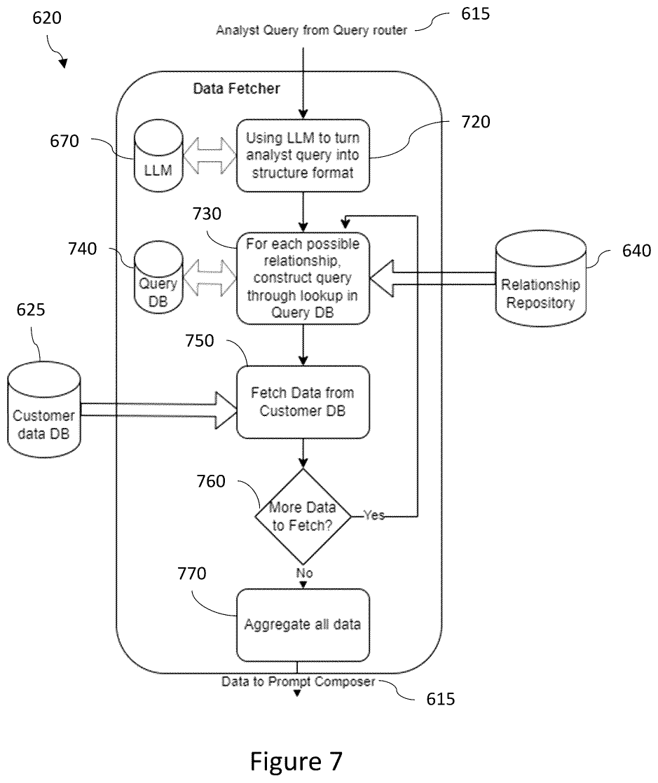

FIG. 7 is a schematic, diagrammatic representation, in hybrid block diagram/flow diagram form, of an example data fetcher 620, in accordance with at least one embodiment of the present disclosure. In step 720, the data fetcher, using the LLM 670, converts the analyst's query 615 into a structured format so the structured information can be used, in step 730, to look up a query from the query database 740 that can be used to fetch, in step 750, appropriate data from the customer data database 625. Some of the questions may require additional information from the relationship repository 640 to find related data such as “find me data similar to this alert”. The relationship repository 650 will provide information that may be critical to find the right customer information. Step 730 may iterate through multiple times until it has looked all the applicable relationships.

In step 760, the data fetcher 620 determines whether there is more data to fetch. If yes, execution returns to step 730. If no, execution proceeds to step 770. In step 770, all of the fetched data from the relationship repository 640 and the customer data database 625 is aggregated to form a data question 615 that can be passed to the prompt composer.

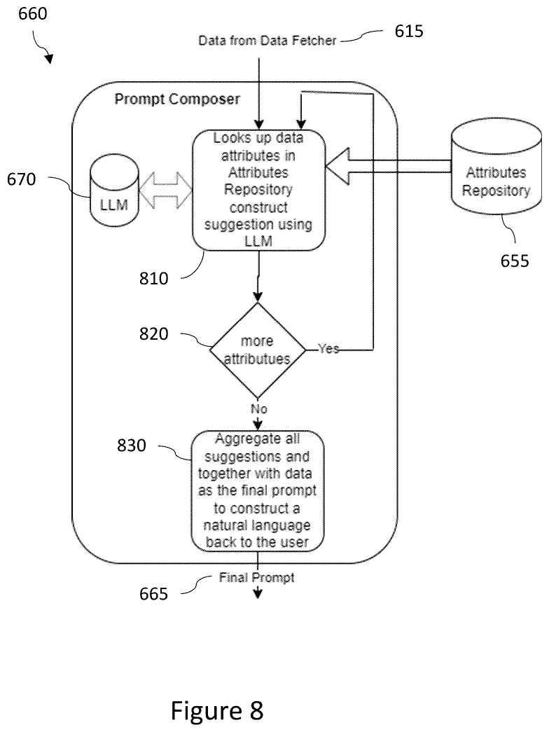

FIG. 8 is a schematic, diagrammatic representation, in hybrid block diagram/flow diagram form, of an example prompt composer 660, in accordance with at least one embodiment of the present disclosure. The prompt composer will construct a prompt for LLM to generate the desired natural language output to the analysts. In additional to the data coming from the Data Fetcher, it will use the information in the attributes repository to identify attributes that make sense to dive deeper into the data. For example, if the data has some location information, it may suggest that we can drill down into country, state or city whenever it is appropriate based on the data we have and what attributes repository suggested. When all applicable attributes have been analyzed, all the suggestions are aggregated with the data to be send to the final state of generating the natural language output from the LLM.

In step 810, the prompt composer 660 receives the data question 615 from the data fetcher and uses it to look up data in the attributes repository 655 and construct a user suggestion using the LLM 670.

In step 820, the prompt composer 660 determines whether there are more attributes to be analyzed. If yes, execution returns to step 810. If no, execution proceeds to step 830.

In step 830, the prompt composer 660 aggregates all of the suggestions, along with the data question 615 and attributes from the attributes repository, to construct a response prompt 665, which can be passed to the LLM to generate a natural language output viewable by the user.

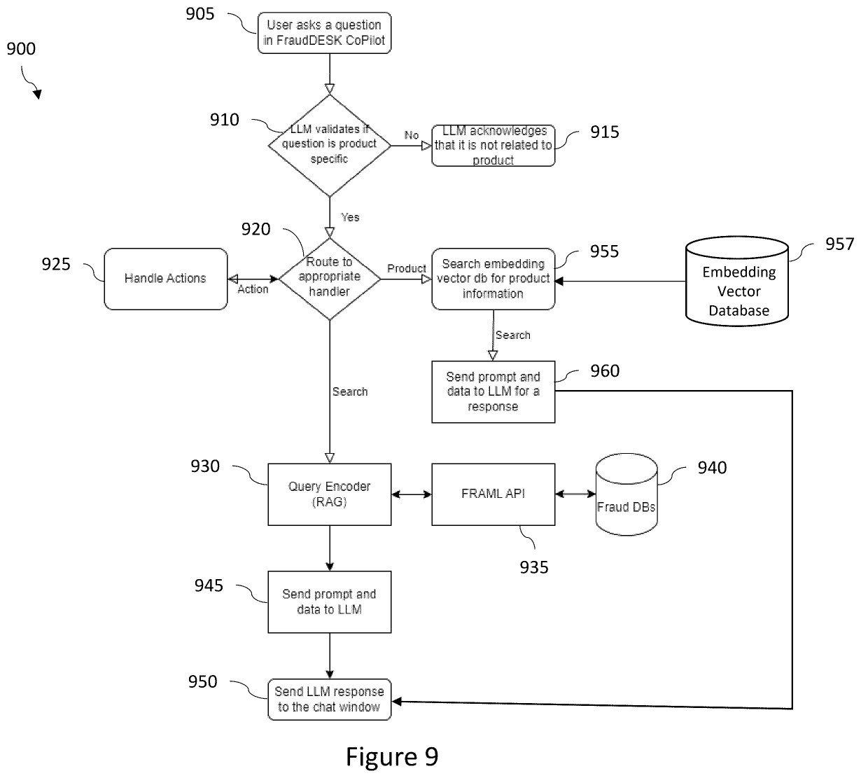

FIG. 9 is a schematic, diagrammatic representation, in hybrid block diagram/flow diagram form, of an example fraud analysis system 900, in accordance with at least one embodiment of the present disclosure.

In step 905, the user asks a natural-language question in a chat window running within the host application (e.g., an assistant or copilot module). Execution then proceeds to step 910.

In step 910, the LLM validates whether the question is specific to one of the allowed products (e.g., a fraud management or fraud analysis product, an account at an allowed institution, etc.). If yes, execution proceeds to step 920. If no, execution proceeds to step 915.

In step 915, the LLM outputs a message indicating that the question is not related to an allowed product. The method is now complete.

In step 920, the fraud analysis system 900 routes the question to an appropriate handler. For example, if the question is requesting an action, then the question is passed to an action handler 925. If the question is related to a product, then the question is passed to a product handler 955 which searches the embedding vector database 957 for product information to construct a relevant prompt that is based on the user's question. If the question is related to a search, the question is passed to a query encoder 930, which uses retrieval-augmented generation (RAG) to access fraud data via an API of the host application, which accesses the fraud databases 940. Execution then proceeds to step 945.

In step 945, the fraud analysis system 900 sends the prompt and data to the LLM, and execution proceeds to step 950.

In step 950, the LLM response is received and posted to the chat window for viewing by the analyst or other user. The method is now complete.

In step 960, the prompt and data are then sent to the LLM, and execution proceeds to step 950.

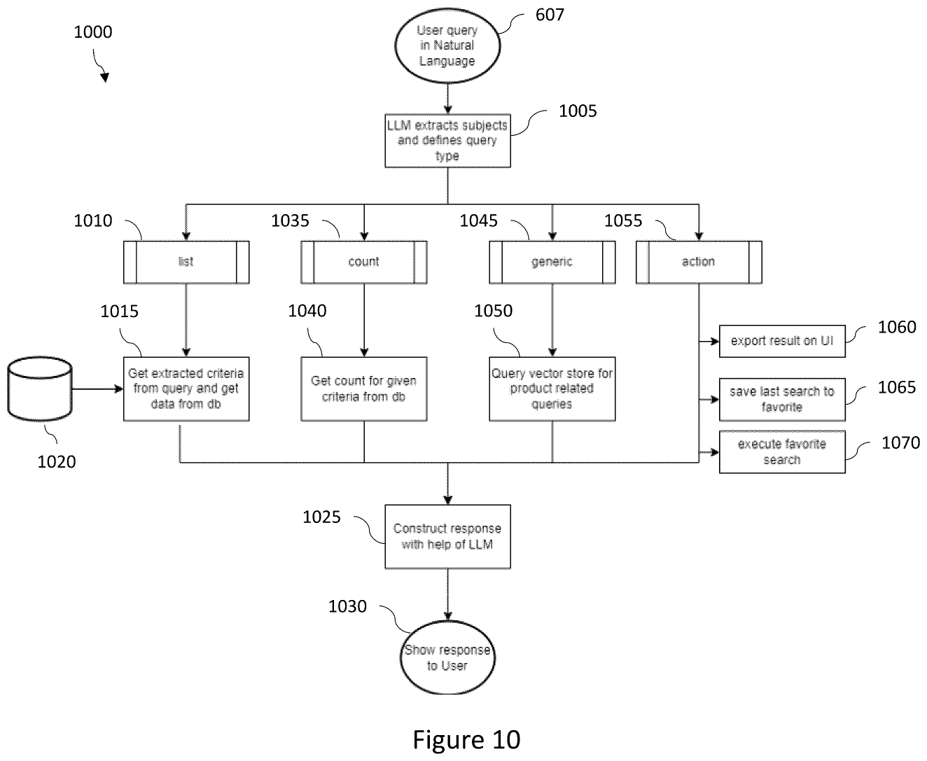

FIG. 10 is a schematic, diagrammatic representation, in hybrid block diagram/flow diagram form, of an example fraud analysis system 1000, in accordance with at least one embodiment of the present disclosure. The fraud analysis system 1000 receives a natural-language user query 607.

In step 1005, the LLM extracts subjects from the query and defines the query type, which may be a list query 1010, a count query 1035, a generic query 1045, or an action query 1055.

For a list query, 1010, step 1015 uses the extracted criteria from the query to fetch appropriate data from a database 1020. Execution then proceeds to step 1025.

For a count query 1035, step 1040 gets the count for the given criteria from a database 1020. Execution then proceeds to step 1025.

For a generic query, step 1050 searches the query vector store for appropriate product-related queries. Execution then proceeds to step 1025.

For an action query 1055, the fraud analysis system 1000 takes one or mor actions such as exporting a result to the user interface (action 1060), saving the last search to a favorites list (action 1060), or executing a favorite search (action 1070).

In step 1025, the fraud analysis system 1000 uses the LLM to construct a response based on the original question and the retrieved data or action.

In step 1030, the fraud analysis system 1000 displays the response to the user (e.g., in a chat window running within the host application). The method is now complete.

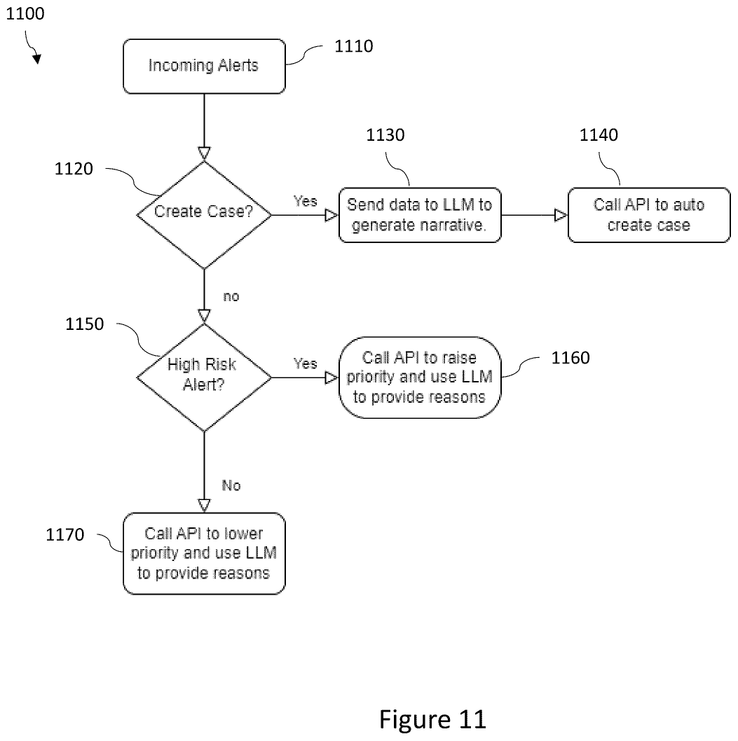

FIG. 11 is a schematic, diagrammatic representation, in flow diagram form, of an example fraud analysis method 1100, in accordance with at least one embodiment of the present disclosure.

In step 1120, the method 1100 includes receiving incoming alerts 1110, and determining whether to create a case. This determination may for example be made by an ML model based on a number, type, or severity of risk factors associated with the alert. If yes, execution proceeds to step 1130. If no, execution proceeds to step 1150.

In step 1130, the method 1100 includes sending the alert data to the LLM to generate a case narrative. Execution then proceeds to step 1140.

In step 1140, the method 1100 includes calling the host application's API to automatically generate the case. The method 1100 is now complete.

In step 1150, the method 1100 includes determining whether the alert is a high-risk alert. If yes, execution proceeds to step 1160. If no, execution proceeds to step 1170.

In step 1160, the method 1100 includes calling the API to raise the priority of the alert and using the LLM to provide a natural-language output explaining the reasons for the raised priority. The method 1100 is now complete.

In step 1170, the method 1100 includes calling the API to lower the priority of the alert and using the LLM to provide a natural-language output explaining the reasons for the lowered priority. The method 1100 is now complete.

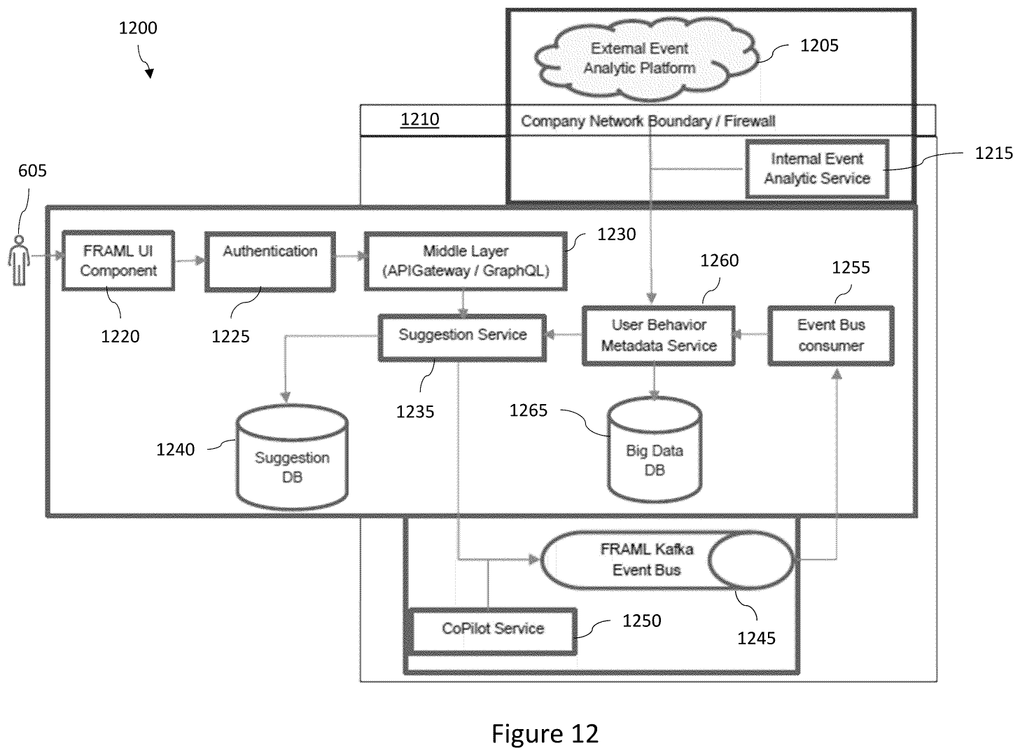

FIG. 12 is a schematic, diagrammatic representation, in block diagram form, of an example fraud analysis system 1200, in accordance with at least one embodiment of the present disclosure. The fraud analysis system 1200 includes an external (e.g., cloud-based) event analytic platform 1205 that sits outside of a network boundary or firewall 1210, and an internal event analytic service 1215 that sits inside the network boundary or firewall. When a transaction is received via the analytic services 1205, 1215, it is passed to a user behavior metadata service 1260 to analyze the transaction as described above, and generate alerts as needed. The user behavior metadata service 1260 feeds a suggestion service 1235 to provide suggestions as described above, which may be passed to a suggestion database 1240 or to an event bus, which passes them to an event bus consumer 1255 and back to the user behavior metadata service. The suggestion service 1235 may also pass suggestions to the assistant service or copilot service 1250, which can append additional data before passing them to the event bus 1245. The user behavior metadata service may also pass data to a big data database 1265.

When a user (e.g., an analyst) 605 posts a query through the user interface 1220, the query is passed to an authenticator 1225, which then selectively passes it (e.g., if it is product-related) to a middle layer 1230, which may for example include an API gateway, graph query language, or other middleware features. The formatted query is then passed to the suggestion service 1235, and thence to the assistant service or copilot service 1250, which communicates with the LLM (not shown).

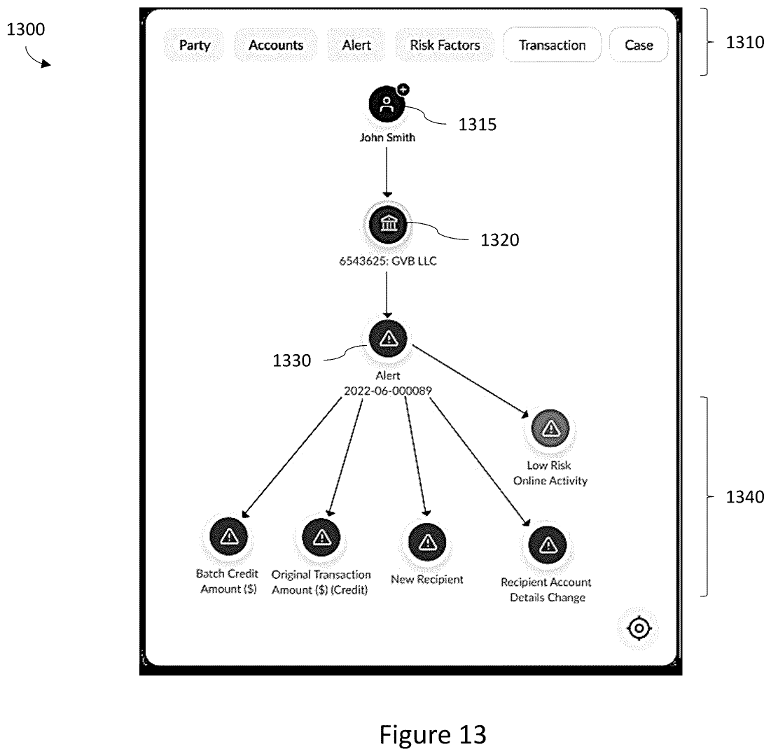

FIG. 13 is a screen display 1300 showing a graphical representation of an alerted transaction, in accordance with at least one embodiment of the present disclosure. The screen display 1300 includes a set of toggle controls 1310, an account holder 1315, account 1320, and an alert 1330. The alert includes a number of risk factors 1340, which an analyst may use to assess whether the alert 1330 fits a known fraud pattern. The screen display 1300 is thus useful for human fraud analysts to facilitate a determination of whether or not to manually open a new case for the alerted transaction.

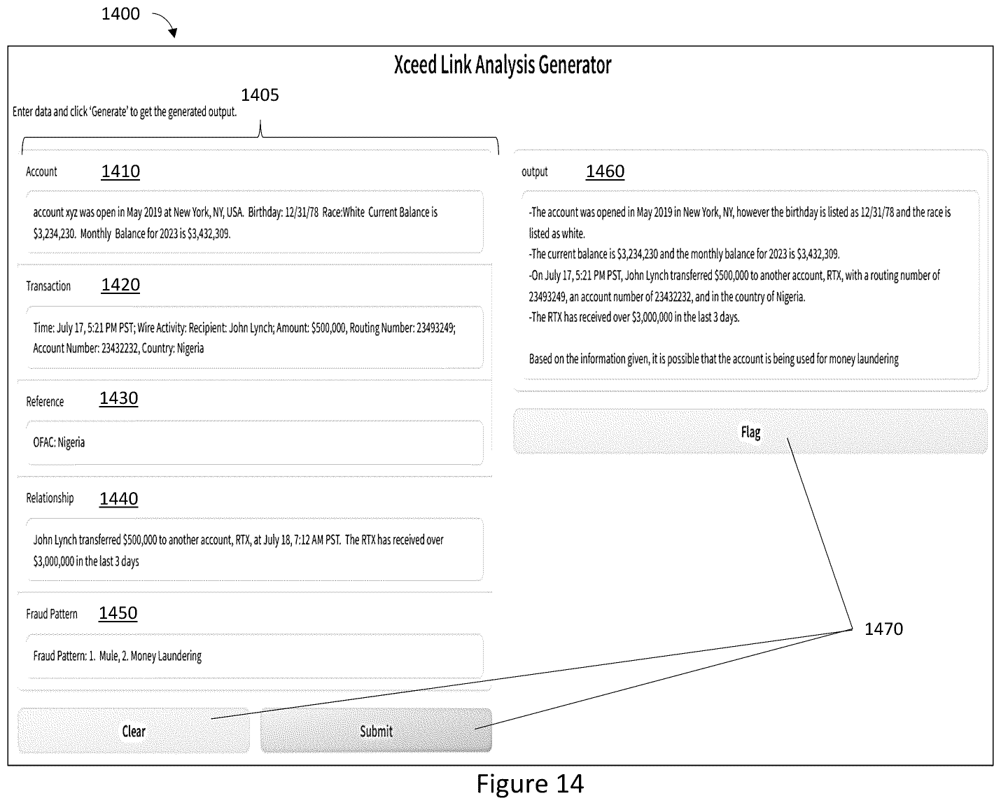

FIG. 14 is a screen display 1400 showing link analysis generation, in accordance with at least one embodiment of the present disclosure. The screen display 1400 includes a variety of inputs 1405 related to the alert. These inputs may be populated automatically by the fraud analysis system (e.g., by the data fetcher 620 or prompt composer 660 of FIG. 6), and may be raw data, natural language data, or a combination thereof. The inputs include account data 1410, transaction data 1420, reference data 1430, relationship data 1440, and fraud pattern data 1450. The screen display 1400 also includes an output window 1460 containing a natural language summary output generated by the LLM based on the inputs 1405, and a set of control buttons 1470.

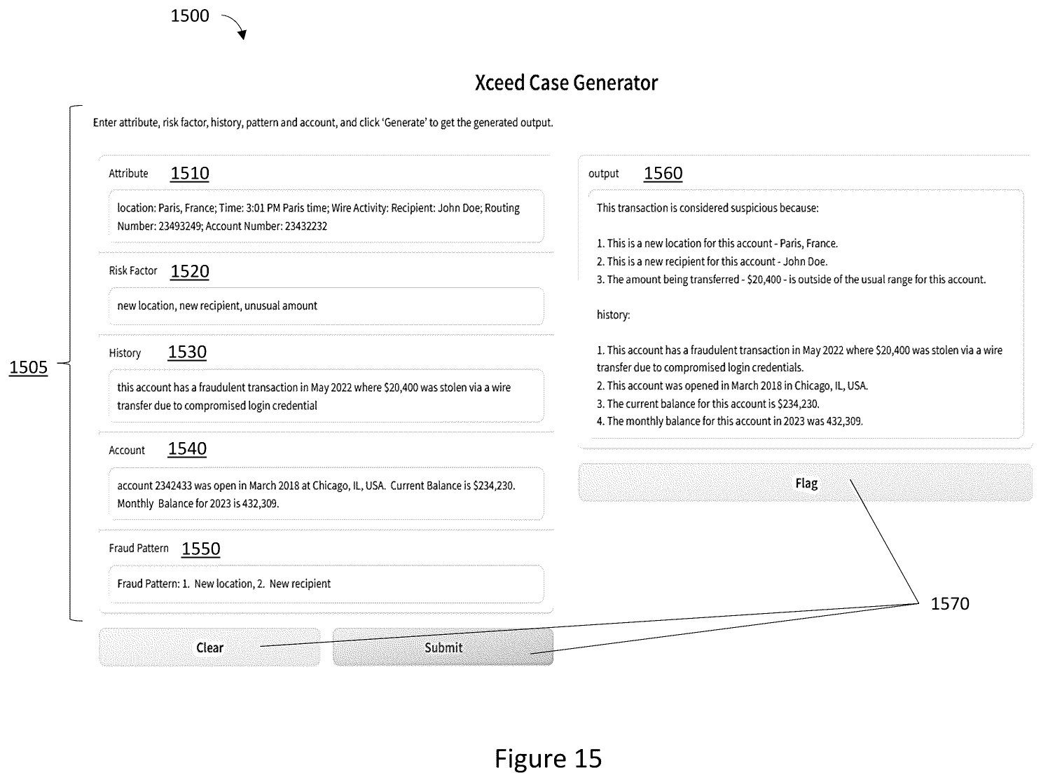

FIG. 15 is a screen display 1500 showing link analysis generation, in accordance with at least one embodiment of the present disclosure. The screen display 1500 includes a variety of inputs 1505 related to the alert. These inputs may be populated automatically by the fraud analysis system (e.g., by the data fetcher 620 or prompt composer 660 of FIG. 6), and may be raw data, natural language data, or a combination thereof. The inputs include attribute data 1510, risk factor data 1520, history data 1530, account data 1540, and fraud pattern data 1550. The screen display 1500 also includes an output window 1560 containing a natural language summary output generated by the LLM based on the inputs 1505, and a set of control buttons 1570.

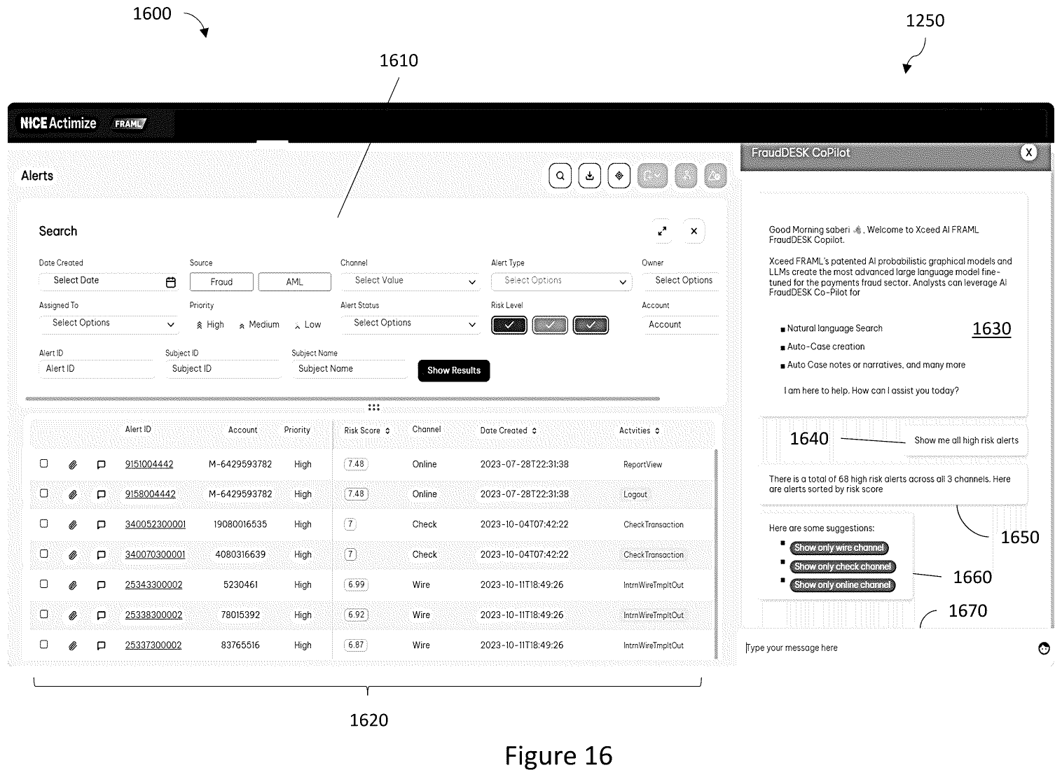

FIG. 16 is a screen display 1600 showing a fraud analysis process in a fraud analysis host application, in accordance with at least one embodiment of the present disclosure. The screen display includes a search window 1610 that the user/analyst can use to search for alerts that meet certain criteria, including but not limited to date, source, channel, assigned analyst, priority, current status, alert type, risk level, alert ID, and identifying details of the subject of the alert. The screen display also includes a results window 1620 that shows the alerts identified by the search, including details such as alert ID, account number, priority, risk score, channel, creation date, and activities that triggered the alert.

In an improvement to the user interface of the host application, the screen display also includes an assistant service or copilot service 1250 (e.g., a chat window) that allows data associated with the alerts to be summarized by the LLM and queried by the user/analyst using natural language questions. In the example shown in FIG. 16, the assistant service 1250 includes a greeting 1630 from the LLM to the user, a question 1640 asked by the user, a response 1650 from the LLM, and a set of suggestions 1660. The suggestions 1660 are indications from the LLM about additional questions the user/analyst may wish to ask about one or more of the identified alerts. Such questions may be typed into a text entry box 1670, although in some embodiments, questions may be asked verbally or by other means.

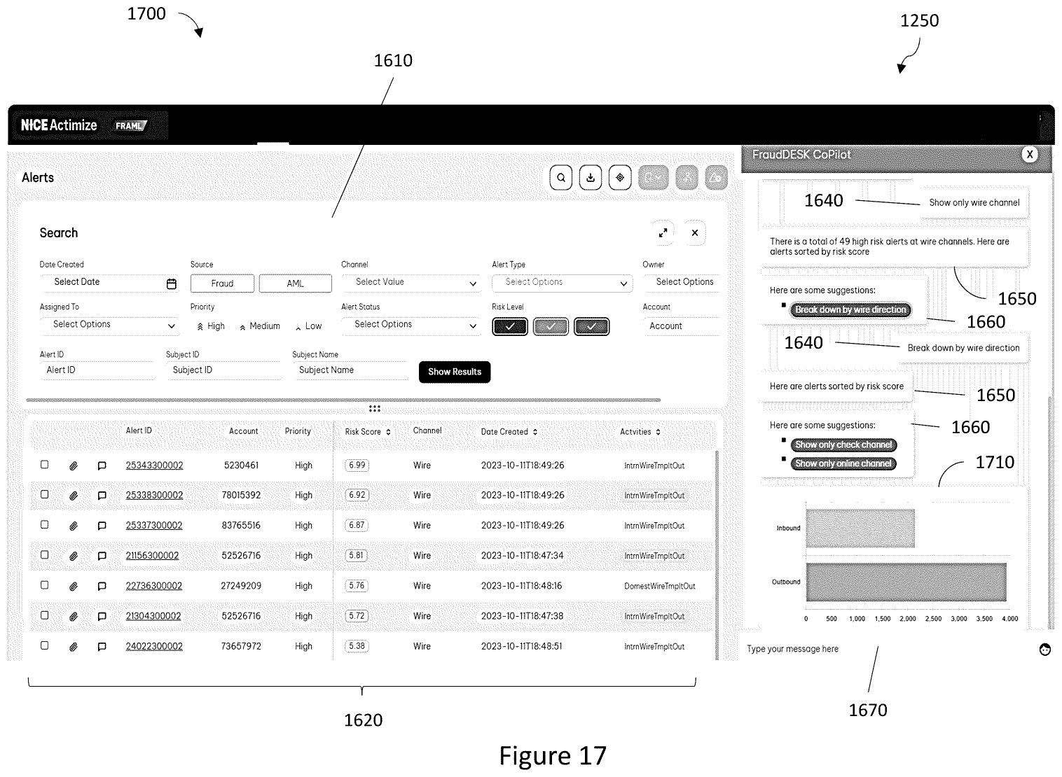

FIG. 17 is a screen display 1700 showing a fraud analysis process in a fraud analysis host application, in accordance with at least one embodiment of the present disclosure. Visible are the search window 1610, results window 1620, and assistant service 1250. In the example shown in FIG. 17, the assistant service 1250 is a chat window currently displaying user questions 1640, LLM text responses 1650, LLM suggestions 1660, and an LLM graphical response 1710 which, in the example of FIG. 17, compares the number of inbound vs. outbound alerts. Also visible is the text entry box 1670.

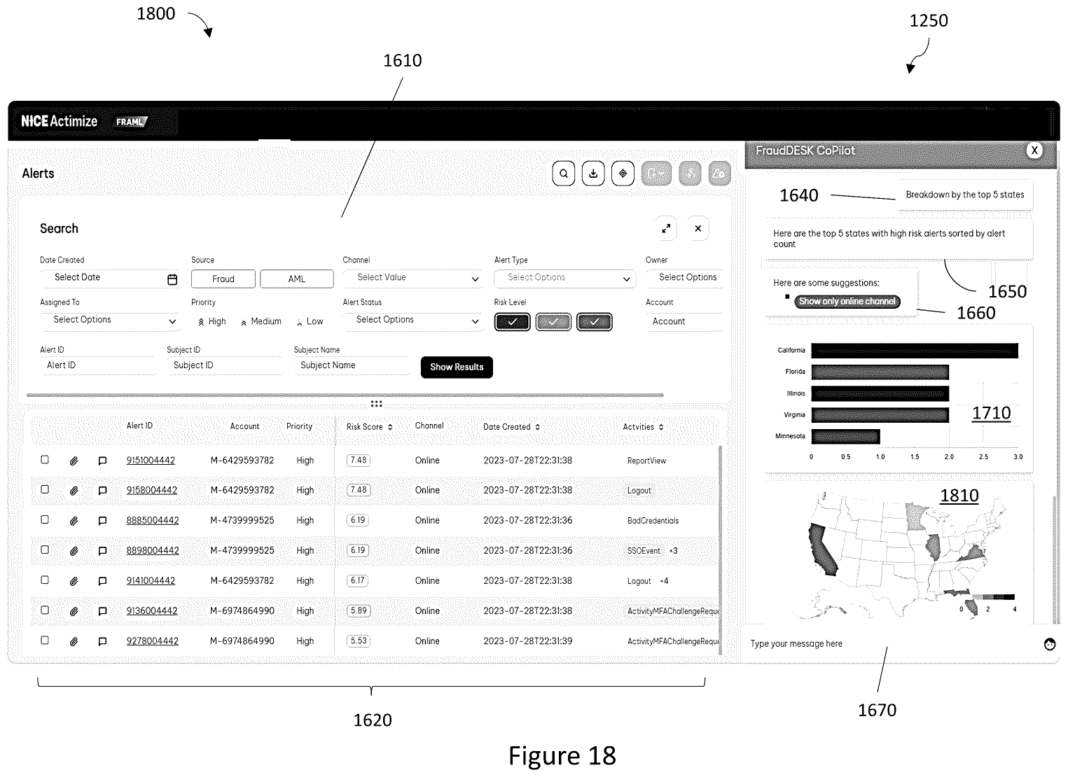

FIG. 18 is a screen display 1800 showing a fraud analysis process in a fraud analysis host application, in accordance with at least one embodiment of the present disclosure. Visible are the search window 1610, results window 1620, and assistant service 1250. In the example shown in FIG. 18, the assistant service 1250 is a chat window currently displaying a user questions 1640, an LLM text response 1650, an LLM suggestion 1660, an LLM graphical response 1710, and an LLM map response 1810 that, in the example of FIG. 18, shows locations of the identified alerts. Also visible is the text entry box 1670.

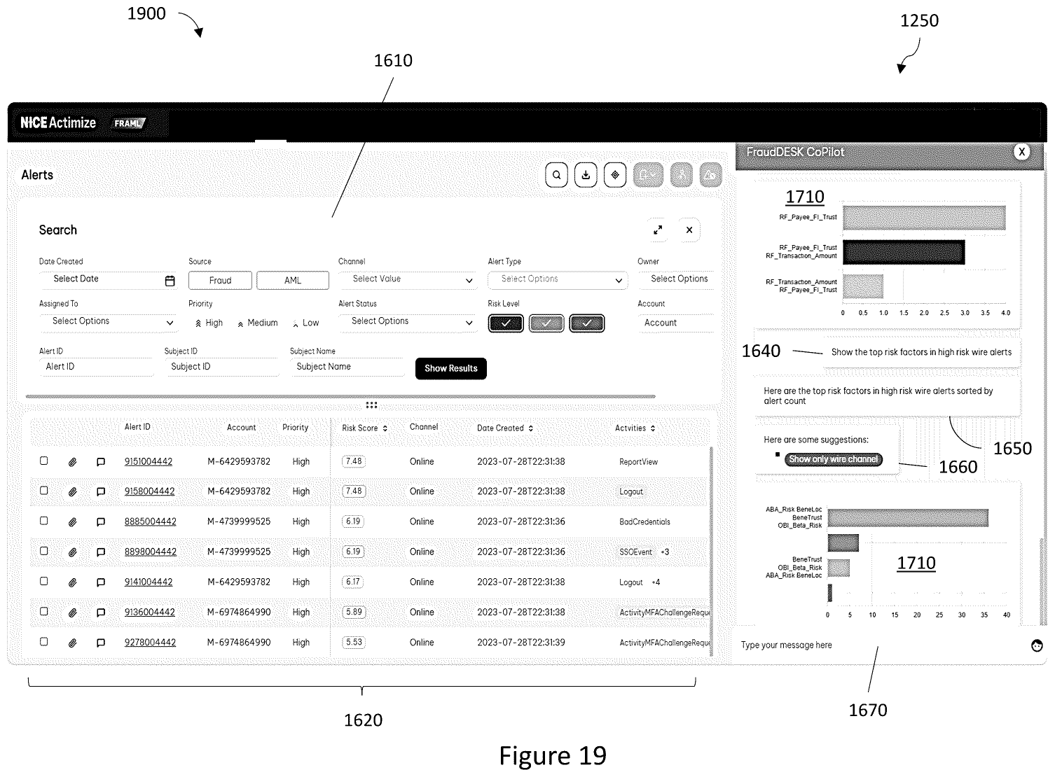

FIG. 19 is a screen display 1900 showing a fraud analysis process in a fraud analysis host application, in accordance with at least one embodiment of the present disclosure. Visible are the search window 1610, results window 1620, and assistant service 1250. In the example shown in FIG. 19, the assistant service 1250 is a chat window currently displaying a user question 1640, an LLM text response 1650, an LLM suggestion 1660, and two LLM graphical responses 1710. Also visible is the text entry box 1670. Thus, it can be seen that when queried by a user question, the LLM can respond with a text reply, a suggestion, a graph, and/or a map.

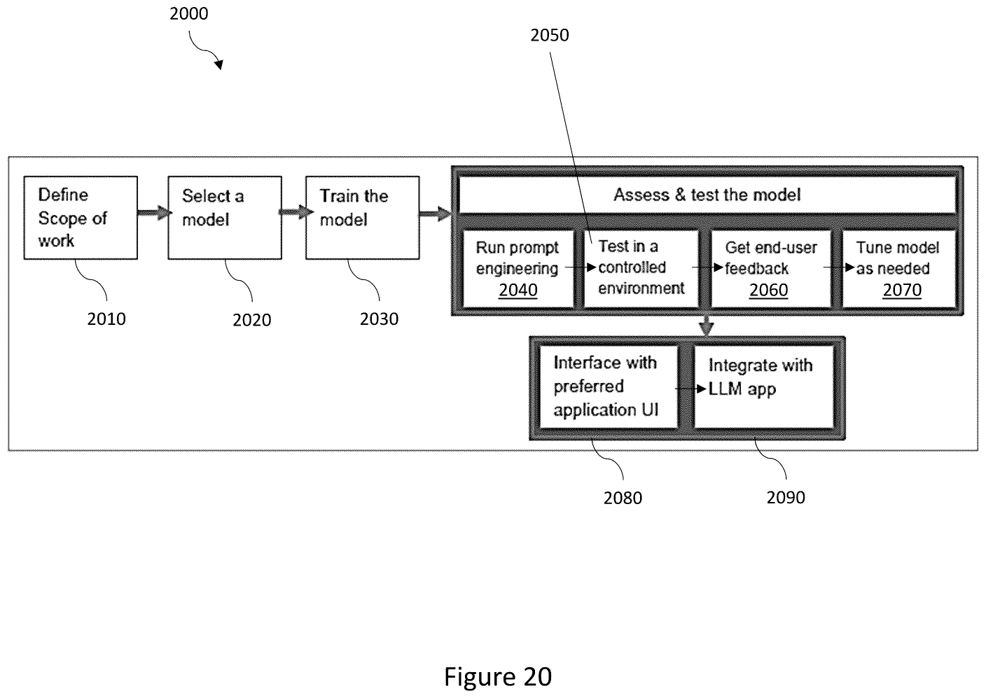

FIG. 20 is a schematic, diagrammatic representation, in flow diagram form, of an example integration method 2000, by which the fraud analysis system can be customized and integrated into a host application, in accordance with at least one embodiment of the present disclosure.

In step 2010, the method 2000 includes defining the scope of work, which may for example include the desired functionality of the fraud analysis system. Execution then proceeds to step 2020.

In step 2020, the method 2000 includes selecting a model, which may for example be or include a machine learning (ML) model and/or a large language model (LLM). Execution then proceeds to step 2030.

In step 2030, the method 2000 includes training the model. This may for example involve feeding the model alerts that are known to be true or false positives, as well as documents, websites, and other data relevant to the fraud analysis process, as will be appreciated by a person of ordinary skill in the art. Training data may include databases, documents, web pages, Internet sites, alter data, case data, risk factors, and confirmed fraud cases. Execution then proceeds to step 2040.

In step 2040, the method 2000 includes running prompt engineering on the model. This may for example involve testing different prompts to see which ones yield the most useful results from the model. Execution then proceeds to step 2050.

In step 2050, the method 2000 includes testing the model in a controlled environment. This may involve using a dataset similar to, but different from, the training dataset, with alerts that are known to be either true positives or false positives. Execution then proceeds to step 2060.

In step 2060, the method 2000 includes obtaining feedback from end users (e.g., fraud analysts) on the functioning of the model. Execution then proceeds to step 2070.

In step 2070, the method 2000 includes tuning the model based on the testing and feedback, until the outputs of the model are deemed to be of acceptable quality and usefulness. Execution then proceeds to step 2080.

In step 2080, the method 2000 includes interfacing the model with the user interface of the host application. This may for example involve adding a chat window to the user interface that permits the user/analyst to interact with the LLM to analyze incoming alerts. Execution then proceeds to step 2090.

In step 2090, the method 2000 includes integrating the user interface improvements with the model (e.g., the ML model or LLM), such that the user/analyst is able to access the features of the model with respect to data associated with the incoming alerts. The method 2000 is now complete.

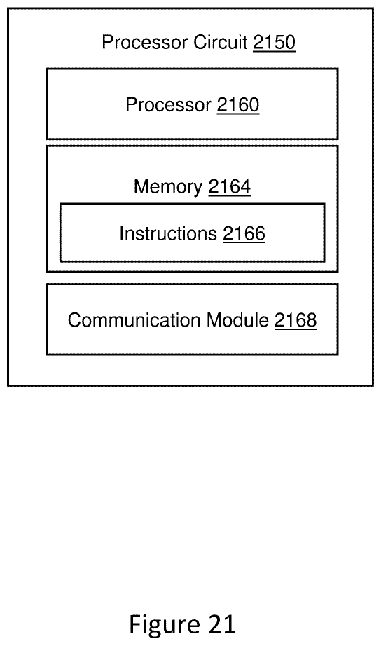

FIG. 21 is a schematic diagram of a processor circuit 2150, in accordance with at least one embodiment of the present disclosure. The processor circuit 2150 may be implemented in the system 300, the system 400, the system 500, the system 600, the system 900, the system 1000, the system 1200, or other devices or workstations (e.g., third-party workstations, network routers, etc.), or on a cloud processor or other remote processing unit, as necessary to implement the method. As shown, the processor circuit 2150 may include a processor 2160, a memory 2164, and a communication module 2168. These elements may be in direct or indirect communication with each other, for example via one or more buses.

The processor 2160 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 2160 may also include another hardware device, a firmware device, or any combination thereof configured to perform the operations described herein. The processor 2160 may also be implemented as a combination of computing devices, e.g., a combination of a DSP and a microprocessor, a plurality of microprocessors, one or more microprocessors in conjunction with a DSP core, or any other such configuration.

The memory 2164 may include a cache memory (e.g., a cache memory of the processor 2160), random access memory (RAM), magnetoresistive RAM (MRAM), read-only memory (ROM), programmable read-only memory (PROM), crasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 2164 includes a non-transitory computer-readable medium. The memory 2164 may store instructions 2166. The instructions 2166 may include instructions that, when executed by the processor 2160, cause the processor 2160 to perform the operations described herein. Instructions 2166 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 2168 can include any electronic circuitry and/or logic circuitry to facilitate direct or indirect communication of data between the processor circuit 2150, and other processors or devices. In that regard, the communication module 2168 can be an input/output (I/O) device. In some instances, the communication module 2168 facilitates direct or indirect communication between various elements of the processor circuit 2150 and/or the fraud analysis system. The communication module 2168 may communicate within the processor circuit 2150 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Acronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from external devices may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

Accordingly, it can be seen that the fraud analysis system disclosed herein advantageously uses machine learning, generative AI, and/or large language models to automate fraud analysis processes traditionally requiring human labor and expertise, resulting not only in savings of time and money, but greater accuracy and repeatability. A number of variations are possible on the examples and embodiments described above. For example, the system disclosed herein can be used not only for fraud operational analysis, but for analysis of anti-money laundering (AML) events and other types of illicit activity, including but not limited to a mule pattern, account take over (ATO), scams, brute force attack (BFA), Internet-online fraud, compromised credentials, phishing, smishing, romance scams, sweepstakes/lottery scams, social engineering, etc.

The logical operations making up the embodiments of the technology described herein are referred to variously as operations, steps, blocks, objects, elements, components, or modules. Furthermore, it should be understood that these may occur, or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the fraud analysis system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the fraud analysis system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically identify patterns of potentially suspicious activity, the system comprising:
a processor and a non-transitory computer readable medium operably coupled thereto, the non-transitory computer readable medium comprising a plurality of instructions stored in association therewith that are accessible to, and executable by, the processor, to perform operations which comprise, in real time or near-real time:
receiving, with a user interface, a natural language user query regarding a potentially suspicious transaction, entity, or event;
with a data fetcher:
converting the natural language user query to a structured query with a large language model and an instruction to the large language model;
fetching relationship data related to the potentially suspicious transaction, entity, or event from a relationship repository;
for each relationship in the relationship data:
constructing a database query based on the structured query;
retrieving, with the database query, a record from a query database;
fetching customer data related to the potentially suspicious transaction, entity, or event from a customer database; and
aggregating the retrieved record, the natural language query, and the customer data into a preliminary prompt;
with a prompt composer:
receiving attributes related to the potentially suspicious transaction, entity, or event from an attributes repository; and
aggregating the attributes and the preliminary prompt with the large language model to compose a response prompt;
generating, with the large language model, a natural language response related to the potentially suspicious transaction, entity, or event based on the response prompt; and
displaying the natural language response to the user with the user interface.

2. The system of claim 1, wherein the relationship data comprises both structured and unstructured data, wherein the structured and unstructured data comprise at least one of customer data, account data, transaction data, alert data, case data, fraud match data, unusual behavior data, possible fraud pattern data, or link analysis data comprising any of the above.

3. The system of claim 1, wherein the customer data comprises past behavior patterns or past confirmed fraud activities.

4. The system of claim 1, wherein the attributes comprise location data, account data, transaction data, reference data, or relationship data related to identifiers from the relationship repository.

5. The system of claim 1, wherein the operations further comprise, based on the attributes, automatically opening a case related to the potentially suspicious transaction, entity, or event.

6. The system of claim 5, wherein the large language model is configured such that the natural language response comprises a case narrative or case description for the potentially suspicious transaction, entity, or event.

7. The system of claim 1, wherein the operations further comprise, with training data, training the large language model.

8. The system of claim 7, wherein the training data comprises at least one of a database, a document, a web page, an Internet site, alter data, case data, risk factors, or a plurality of confirmed fraud cases.

9. The system of claim 1, wherein the operations further comprise, with an attributes analyzer and a plurality of fraud cases, populating the attributes repository.

10. The system of claim 1, wherein the operations further comprise, with a relationship analyzer and a plurality of fraud cases, populating the relationship repository.

11. A computer-implemented method, the method comprising:
with a processor and a non-transitory computer readable medium operably coupled thereto, in real time or near real time:
receiving, with a user interface, a natural language user query regarding a potentially suspicious transaction, entity, or event;
with a data fetcher:
converting the natural language user query to a structured query with a large language model and an instruction to the large language model;
fetching relationship data related to the potentially suspicious transaction, entity, or event from a relationship repository;
for each relationship in the relationship data:
constructing a database query based on the structured query;
retrieving, with the database query, a record from a query database;
fetching customer data related to the potentially suspicious transaction, entity, or event from a customer database; and
aggregating the retrieved record, the natural language query, and the customer data into a preliminary prompt;
with a prompt composer:
receiving attributes related to the potentially suspicious transaction, entity, or event from an attributes repository; and
aggregating the attributes and the preliminary prompt with the large language model to compose a response prompt;
generating, with the large language model, a natural language response related to the potentially suspicious transaction, entity, or event based on the response prompt; and
displaying the natural language response to the user with the user interface.

12. The computer-implemented method of claim 11, wherein the relationship data comprises additional potentially suspicious transaction, entity, or events similar to the potentially suspicious transaction, entity, or event.

13. The computer-implemented method of claim 11, wherein the customer data comprises wherein the customer data comprises past behavior patterns or past confirmed fraud activities.

14. The computer-implemented method of claim 11, wherein the attributes comprise location data, account data, transaction data, or reference data.

15. The computer-implemented method of claim 11, wherein the operations further comprise, based on the attributes, automatically opening a case for the potentially suspicious transaction, entity, or event.

16. The computer-implemented method of claim 15, wherein the large language model is configured such that the natural language response comprises a case narrative or case description for the potentially suspicious transaction, entity, or event.

17. The computer-implemented method of claim 11, further comprising, with training data, training the large language model.

18. The computer-implemented method of claim 17, wherein the training data comprises at least one of a database, a document, a web page, an Internet site, or a plurality of fraud cases.

19. The computer-implemented method of claim 11, further comprising, with an attributes analyzer and a plurality of fraud cases, populating the attributes repository.

20. The computer-implemented method of claim 11, further comprising, with a relationship analyzer and a plurality of fraud cases, populating the relationship repository.
